(19) United States
(12) Patent Application Publication
(10) Pub. No.: US 2010/0100769 A1
(43) Pub. Date: Apr. 22, 2010

(54) POWER ON SELF TEST DEVICE AND COMPUTER SYSTEM APPLYING THE SAME

(75) Inventors: Chao-Chung Wu, Taipei (TW); Chien-Shien Lin, Taipei (TW)

Correspondence Address: KIRTON AND MCCONKIE, 60 EAST SOUTH TEMPLE,, SUITE 1800, SALT LAKE CITY, UT, 84111, US

(73) Assignee: ASUSTEK COMPUTER INC., Taipei (TW)

(21) Appl. No.: 12/575,761

(22) Filed: Oct. 8, 2009

(30) Foreign Application Priority Data
Oct. 17, 2008 (TW) 097139935

(51) Int. Cl. G06F 11/22; G06F 15/177

(52) U.S. Cl. 714/36; 713/2; 714/E11.149

(57) ABSTRACT

A power on self test (POST) device and a computer system applying the same are disclosed, wherein the POST device comprises a micro controller and a displaying unit. The micro controller is embedded on a motherboard of the computer system for receiving a plurality of POST codes generated by the computer system during a booting procedure and transforming the POST codes into a displaying signal. The displaying unit which is capable for receiving and showing the displaying signal is connected to the micro controller through a flexible line.

### FIELD OF THE INVENTION

The present invention relates to a power on self test device and more particularly to an external power on self test device applied in a computer system.

### BACKGROUND OF THE INVENTION

In a computer system, a basic input output system (BIOS) disposed on a motherboard generally has a built-in self test program. During a booting procedure, a central processing unit (CPU) of the computer system should execute the self test program to check the hardware condition. If the self test is executed completely, it means that the hardware of the computer system has been well-tested and is available for succeeding operation. Otherwise, it means that some hardware failures, such as memory defeats, display card failure or chip set failure, have been detected.

When the hardware failures are detected, the computer system may be crashed and the self test program can not be continued any more. At this situation, users of this computer system cannot realize anything except that the booting procedure is failure.

To resolve preceding drawbacks, a power on self test (POST) device, also denominated as “debug card” that is connected to the computer system via a bus, i.e. a PCI bus, has been provided by computer designers. When the self test program is executed by the CPU, a series of POST codes can be generated and then transmitted to the POST device through specific bus so as to be displayed thereon. For example, when the self test is conducted to check memories of the computer system, a first POST code generated by the self test program is transmitted to and then displayed on the POST device. After the memory check is completed, the self test may be continued to check the display card, whereby a second POST code is generated and then displayed on the POST device. Similarly, when the self test is conducted to check other hardware various codes may be generated and correspondently displayed on the POST device.

Therefore, when a hardware failure is detected by the self test program to cause the computer system crashed, the users can determine what kind of hardware failure occurs by observing the POST code displayed on the POST device, and eliminate the hardware failure.

Besides the computer designers, some power users can also determine the hardware failures by observing the POST device. Accordingly, the BIOS parameters for over clocking or over voltage the computer system can be adjusted to optimize the performance of the computer system.

For some instance, after an over clocking procedure is conducted, when the computer system is reset and then crashed, the power users may be informed by the first POST code that the memories over clocking is failed, whereby the power users can reduce the clock frequency of the memories to overcome the failed over clocking procedure according to the first POST code. In contrast, when the self test program can be executed completely by the computer system, the power users cam realize that this over clocking procedure has been well done, and other trials for over clocking the computer system, such as increasing the clock frequency of the memories, can be conducted.

FIG. 1 illustrates a POST device 10 embodied as an interface card in accordance with the prior art. This type of the POST device 10 can be inserted in a bus, such as a PCI bus, of a computer system. Two 7 segment displays, depicted as boxes 12 and 14, used to display the POST codes is disposed on the POST device 10. When the self test program is executed, various POST codes generated by the self test program can be sequentially transmitted to the POST device 10 through the 80h port of the PCI bus, and the POST codes are then received by the POST device 10 and shown on the two 7 segment displays 12 and 14.

Hence a computer system usually embedded in a housing case which has a design trend as thin and small, it is necessary to open the housing case of the computer system when a user wants to observe the POST codes shown on the two 7 segment displays 12 and 14. However, sometimes there are too many interface cards inserted in the computer system. Even though the housing is opened, nevertheless, other interface cards may still obstruct the user's view to observe the two 7 segment displays 12 and 14.

FIG. 2 illustrates a POST 170 device integrated on a motherboard 100 in accordance with the prior art. As depicted in FIG. 2, the motherboard 100 comprises a CPU 110, a north bridge 122, a south bridge 126, a memory 140, a graphic chip 130, a BIOS 150 and the POST device 170, wherein the combination of the north bridge 122 and the south bridge 126 is regarded as a “chip set 120”.

The chip set 120 is respectively connected to the CPU 110, the memory 140, the graphic chip 130, the BIOS 150 and the POST device 170, wherein the POST device 170 is directly lay out on the motherboard 100, such that the two 7 segment displays 172 and 174 used for displaying the POST codes are directly welded on the motherboard 100. In this exemplar, the POST device 170 is connected to the chip set 120 through a PCI bus that is provided by the chip set 120. When the self test program is executed, various POST codes generated by the self test program can be transmitted to the POST device 170 through the 80h port of the PCI bus, and the users can observe the POST codes shown on the two 7 segment displays 172 and 174.

In this approach, however, the computer system is still embedded in and covered by the hosing case. The users cannot directly observe the POST codes shown on the two 7 segment displays 172 and 174, unless the hosing case is opened. Furthermore, it is inconvenient to replace the two 7 segment displays 172 and 174 when they are invalid; and without opening the housing case, the users even cannot determine weather the two 7 segment displays 172 and 174 are available or not. Therefore, the user may likely receive fake POST codes, thus the hardware failures occurring on the computer system cannot be eliminated.

### SUMMARY OF THE INVENTION

One aspect of the present invention, a power on self test (POST) device applied in a computer system is disclosed, wherein the POST device comprises a micro controller and a displaying unit. The micro controller is embedded on a motherboard of the computer system for receiving a plurality of POST codes generated by the computer system during a booting procedure and transforming the POST codes into a displaying signal. The displaying unit which is capable for receiving and showing the displaying signal is connected to the micro controller through a flexible line.

Another aspect of the present invention, A computer system is disclosed, wherein the computer system comprises a chip set, a basic input output system (BIOS) connected to the chip set, a central processing unit (CPU) connected to the chip set capable for executing a self test program built-in the BIOS to generate a plurality of POST codes, and a micro controller connected to the chip set for receiving and transforming the plurality of POST codes into a displaying signal, wherein the micro controller is connected to an external displaying unit capable for showing the displaying signal through a flexible line.

To illustrate the make and use of the present invention, there provides several embodiments and the accompanying drawings. However, it must be appreciated that, the embodiments and drawings are illustrative but not intended to limit the scope of the present invention.

### BRIEF DESCRIPTION OF THE DRAWINGS

The above objects and advantages of the present invention will become more readily apparent to those ordinarily skilled in the art after reviewing the following detailed description and the accompanying drawings, in which:

FIG. 1 illustrates a POST device embodied as an interface card in accordance with the prior art.

FIG. 2 illustrates a POST device integrated on a motherboard in accordance with the prior art.

FIG. 3 illustrates an external POST device and the computer system applying the same in accordance with one embodiment of the present invention.

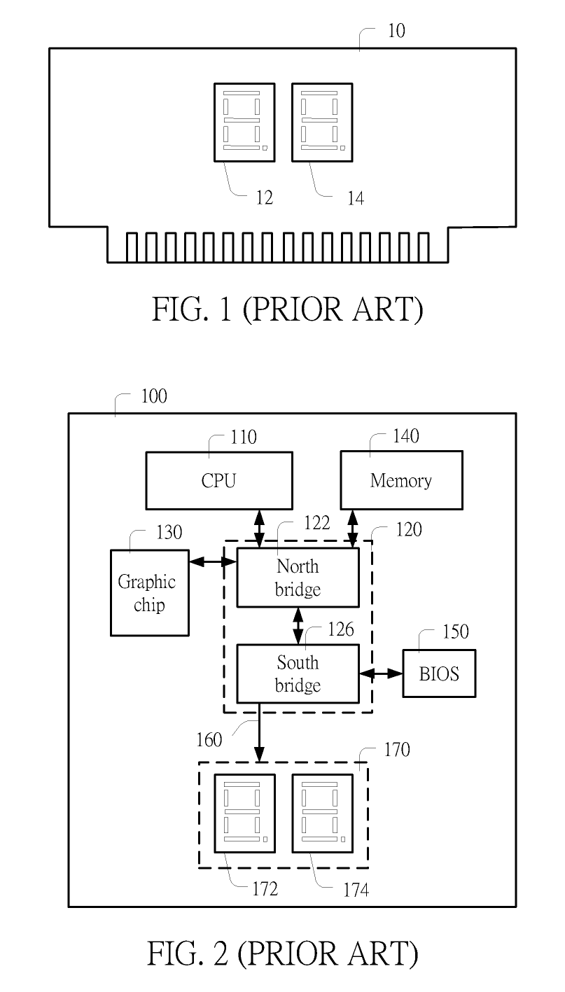

### DETAILED DESCRIPTION OF PREFERRED EMBODIMENTS

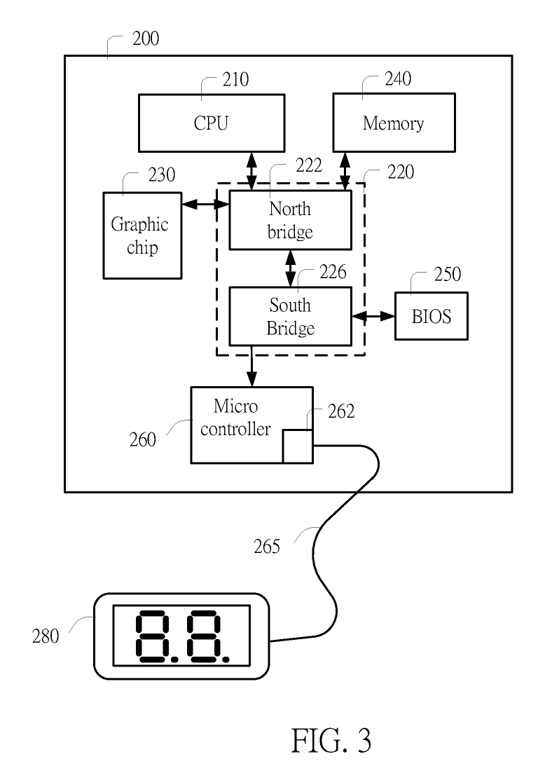

FIG. 3 illustrates an external POST device and the computer system applying the same in accordance with one embodiment of the present invention. As depicted in FIG. 3, the motherboard 200 of the computer system comprises a CPU 210, a north bridge 222, a south bridge 226, a memory 240, a graphic chip 230, a BIOS 250 and a micro controller 260, where the combination of the north bridge 222 and the south bridge 226 is regarded as a chip set 220.

In the present embodiment, the chip set 220 is electrically connected to the CPU 210, the graphic chip 230, the BIOS 250 and the micro controller 260 respectively; and the micro controller 260 is electrically connected to an external displaying unit 280, such as a liquid crystal display (LCD), through a flexible line 265.

When a self test program built in the BIOS 250 is executed by the central CPU 210, various POST codes can be transmitted to the micro controller 260, and the POST codes are transformed into a displaying signal by a display interface conversion unit 262 disposed in the micro controller 260. The displaying signal is then transmitted to and shown on the external displaying unit 280. Thus the POST codes of the computer system can be observed by the users though the external displaying unit 280 without opening the housing case of the computer system during the booting procedure.

In accordance with the preferred embodiment, the aforementioned external POST device comprises the micro controller 260 and the displaying unit 280 that is connected to the micro controller 260 by the flexible line 265, wherein the displaying unit 280 is disposed outside the housing case of the computer system. Since the displaying unit 280 is disposed outside the housing case of the computer system rather than embedded in the computer system, thus the users can monitor the booting procedure of the computer system by observing the POST codes though the external displaying unit 280 without opening the housing case of the computer system.

To ensure the displaying signal generated by the micro controller 260 can be accurately transmitted for a long distance to the displaying unit 280, the POST codes transmitted from the CPU 210 are transformed into a signal (the displaying signal) conforms to a specification suitable for a system management bus (SM Bus) or an inter-integrated circuit by the display interface conversion unit 262 of the micro controller 260.

In accordance with the aforementioned description, the advantages of the present invention are to provide a computer system a micro controller that is electrically connected to an external displaying unit. Since the displaying unit is disposed outside the housing case of computer system rather than embedded in the computer system, thus the POST codes of the computer system can be monitored by the users though the external displaying unit without opening the housing case of the computer system during the booting procedure.

As is understood by a person skilled in the art, it is intended to cover various modifications and similar arrangements included within the spirit and scope of the appended claims, the scope of which should be accorded the broadest interpretation so as to encompass all such modifications and similar structure.

What is claimed is:

1. A power on self test (POST) device applied in a computer system comprising:
a micro-controller, embedded on a motherboard of the computer system for receiving a plurality of POST codes generated by the computer system during a booting procedure and transforming the POST codes into a displaying signal; and
a displaying unit, connected to the micro controller capable for receiving and showing the displaying signal through a flexible line.

2. The POST device according to claim 1, wherein the displaying unit is disposed outside the motherboard of the computer system.

3. The POST device according to claim 1, wherein the displaying unit is disposed outside a housing case of the computer system.

4. The POST device according to claim 1, wherein the displaying signal conforms to a specification suitable for a system management bus (SM Bus).

5. The POST device according to claim 1, wherein the displaying signal conforms to a specification suitable for an inter-integrated circuit.

6. The POST device according to claim 1, wherein the displaying unit comprises a liquid crystal display (LCD).

7. A computer system comprising:
a chip set;
a BIOS, connected to the chip set;
a CPU, connected to the chip set capable for executing a self test program built in the BIOS to generate a plurality of POST codes; and
a micro controller, connected to the chip set for receiving and transforming the POST codes into a displaying signal, wherein the micro controller is connected to an external displaying unit capable for showing the displaying signal through a flexible line.

8. The computer system according to claim 7, wherein the displaying signal conforms to a specification suitable for a SM Bus.

9. The computer system according to claim 7, wherein the displaying signal conforms to a specification suitable for an inter-integrated circuit.

10. The computer system according to claim 7, wherein the displaying unit comprises a LCD.
